(19) United States
(12) Patent Application Publication
(10) Pub. No.: US 2023/0163383 A1
(43) Pub. Date: May 25, 2023

(54) BATTERY PACK

(71) Applicant: HYUNDAI MOBIS CO., LTD., Seoul (KR)

(72) Inventors: Won Yong KI, Yongin-si (KR); Seung Jun LEE, Yongin-si (KR)

(73) Assignee: HYUNDAI MOBIS CO., LTD., Seoul (KR)

(21) Appl. No.: 17/952,390

(22) Filed: Sep. 26, 2022

(30) Foreign Application Priority Data
Nov. 24, 2021 (KR) 10-2021-0163732

(51) Int. Cl. H01M 10/6568; H01M 10/613; H01M 10/643; H01M 10/48

(52) U.S. Cl. CPC H01M 10/6568; H01M 10/613; H01M 10/643; H01M 10/48; H01M 2220/20

(57) ABSTRACT

Disclosed is a battery back that includes a housing that has a receiving space formed within, battery cells accommodated in the receiving space and supported by the housing, and a cooling block that is accommodated in the receiving space. The cooling block includes cell insertion parts. The cell insertion parts include a top opening and a bottom opening, such that the battery cells are inserted into the cell insertion parts and a cooling chamber in which cooling water flows. The cooling block also includes an upper plate coupled to upper end portions of the cell insertion parts, a lower plate coupled to lower end portions of the cell insertion parts, and a pair of side plates that connects the upper plate and the lower plate.

### CROSS-REFERENCE TO RELATED APPLICATIONS

This application claims the benefit under 35 USC § 119(a) of Korean Patent Application No. 10-2021-0163732, filed on Nov. 24, 2021, in the Korean Intellectual Property Office, the entire disclosure of which is incorporated herein by reference for all purposes.

### BACKGROUND

### 1. Field

The present disclosure relates to a battery pack.

### 2. Description of Related Art

Environmentally-friendly vehicles, such as a hybrid electric vehicle and an electric vehicle, are equipped with a battery pack for applying power to an electric motor. The battery pack includes a plurality of battery cells.

In some instances, the battery pack includes a cartridge supporting the battery cells, a cooling block cooling the battery cells, and busbars connecting negative electrodes and positive electrodes of the battery cells. The cartridge may have a structure surrounding the battery cells and may perform a function of supporting the battery cells and a function of protecting the battery cells from an external impact. The cooling block may perform a function of cooling heat of surfaces of the battery cells.

However, the cartridge supporting the battery cells and the cooling block cooling the battery cells are separately manufactured, and therefore the battery pack in these instances has a problem in which the use of space in the battery pack is lowered. Furthermore, a separate assembly structure is required between the cartridge and the cooling block to bring the battery cells and the cooling block into close contact with each other, and therefore manufacturability may be deteriorated. In addition, when the cartridge is damaged by an external impact and the battery cells make contact with the cooling block, insulation may be broken, and therefore an electrical hazard may occur.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, here is provided a battery pack that includes a housing having a receiving space formed therein, and a cooling block that is accommodated in the receiving space. The cooling block includes cell insertion parts. The cell insertion parts include a top opening and a bottom opening, such that the battery cells are inserted into the cell insertion parts and a cooling chamber in which cooling water flows. The cooling block also includes an upper plate coupled to upper end portions of the cell insertion parts, a lower plate coupled to lower end portions of the cell insertion parts, and a pair of side plates that connects the upper plate and the lower plate.

The upper plate and the lower plate are formed to surround ends of the side plates in areas in which the upper plate and the lower plate meet the side plates.

A direction from upper end portions of the battery cells toward lower end portions of the battery cells may be referred to as a first direction. The side plates may extend in a second direction. The second direction may be a direction in which the cooling block extends that is perpendicular to the first direction. The side plates may be spaced apart from each other in a third direction. The third direction may be a direction that is perpendicular to the first direction and to the second direction.

The upper plate and the lower plate may include first curved portions formed at portions connected with the cell insertion parts and having a curved shape. The cell insertion parts may include, at the upper and lower end portions, first hemming portions bent toward the upper plate and the lower plate and formed to surround the first curved portions.

The side plates may include second curved portions formed at portions connected with the upper plate and the lower plate and having a curved shape. The upper plate and the lower plate may include, at end portions facing toward the side plates, second hemming portions bent to surround the second curved portions.

The cooling block may include an inlet part and an outlet part. The inlet part may be formed at one end of the side plates in the second direction. The inlet part may have an inlet formed therein through which the cooling water flows into the cooling chamber. The outlet part may be formed at an opposite end of the side plates in the second direction. The outlet part may have an outlet formed therein through which the cooling water flows out of the cooling chamber.

The inlet part may include an inlet plate and an inclined inlet plate. The inlet plate may be provided at one end of the inlet part in the third direction. The inlet plate may have the inlet formed therein. The inclined inlet plate may extend from the inlet plate and incline toward the outlet part with an approach to an opposite end of the inlet part in the third direction. The outlet part may include an outlet plate and an inclined outlet plate. The outlet plate may be provided at an opposite end of the outlet part in the third direction. The outlet plate may have the outlet formed therein. The inclined outlet plate may extend from the outlet plate and incline toward the inlet part with an approach to one end of the outlet part in the third direction.

The housing may include an upper cover that covers the upper end portions of the battery cells, and a lower cover that forms the receiving space together with the upper cover and cover the lower end portions of the battery cells. The upper cover and the lower cover are coupled to the cooling block by a snap-fit connection.

The cooling block may include upper assembly protrusions and lower assembly protrusions that protrude from the side plates and extend in the second direction, and are spaced apart from each other in the first direction. The upper cover includes, on inside surfaces, upper insertion grooves into which the upper assembly protrusions are inserted. The lower cover includes, on inside surfaces, lower insertion grooves into which the lower assembly protrusions are inserted.

The upper cover, the lower cover, and the side plates may be bonded by thermal fusion or welding.

The cooling block may include an inlet formed at one end of the cooling block in the second direction, and an outlet formed at an opposite end of the cooling block in the second direction. The upper cover may include an inlet recess and an outlet recess. The inlet recess may be formed in one end portion of the upper cover in the second direction, and the inlet may pass through the inlet recess. The outlet recess may be formed in an opposite end portion of the upper cover in the second direction, and the outlet may pass through the outlet recess.

The battery pack may include a sensing assembly that monitors voltages of the battery cells. The upper cover may include an upper horizontal plate provided to be horizontal and an upper vertical plate formed perpendicular to the upper horizontal plate and assembled to the cooling block. The upper horizontal plate may include one or more fixing protrusions formed on an inside surface facing toward the receiving space and to which the sensing assembly is fixed.

The one or more fixing protrusions may include multiple fixing protrusions spaced apart from each other along a periphery of a circuit board included in the sensing assembly. The multiple fixing protrusions may be coupled to edges of the circuit board by a snap-fit connection.

The lower cover may include a lower horizontal plate provided to be horizontal and a lower vertical plate formed perpendicular to the lower horizontal plate and assembled to the cooling block. The lower horizontal plate may include a support guide that protrudes from an inside surface of the lower horizontal plate facing toward the receiving space, to guide arrangement of the battery cells, and to support the lower end portions of the battery cells.

The support guide may be formed along edges of end portions of the battery cells facing the direction from the upper end portions of the battery cells toward the lower end portions. The support guide may include support portions brought into close contact with side surfaces of the battery cells to support the battery cells and protrusions that extend from the support portions to be bent. The protrusions may be provided to correspond to positions between the battery cells.

Other features and aspects will be apparent from the following detailed description, the drawings, and the claims.

### BRIEF DESCRIPTION OF THE DRAWINGS

FIG. 1 is a perspective view illustrating a battery pack according to an embodiment of the present disclosure.

FIG. 2 is an exploded perspective view illustrating the battery pack according to an embodiment of the present disclosure.

FIG. 3 illustrates a sectional view of the battery pack and an enlarged view of a portion of a section of the battery pack according to an embodiment of the present disclosure.

FIG. 4 is a top view illustrating a cooling block according to an embodiment of the present disclosure.

FIG. 5 is a side view illustrating the cooling block according to an embodiment of the present disclosure.

FIG. 6 is a view of the cooling block according to an embodiment of the present disclosure as viewed from an inlet side of the cooling block illustrated in FIG. 2.

FIG. 7 is a view illustrating a state before the cooling block is assembled according to an embodiment of the present disclosure.

FIGS. 8A to 8E are views for describing an assembly process of the cooling block according to an embodiment of the present disclosure.

FIG. 9 is a view for describing a structure in which a battery cell is supported by a lower cover in an embodiment of the present disclosure.

FIG. 10 is a view for describing a structure in which a sensing assembly is fixed by an upper cover in an embodiment of the present disclosure.

FIG. 11 is a view illustrating one example in which a plurality of battery packs are provided according to an embodiment of the present disclosure.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Advantages and features of the present disclosure and methods of achieving the advantages and features will be clear with reference to embodiments described in detail below together with the accompanying drawings. However, the present disclosure is not limited to the embodiments disclosed herein but will be implemented in various forms. The embodiments of the present disclosure are provided so that the present disclosure is completely disclosed, and a person with ordinary skill in the art can fully understand the scope of the present disclosure. The present disclosure will be defined only by the scope of the appended claims. Meanwhile, the terms used in the present specification are for explaining the embodiments, not for limiting the present disclosure.

Terms, such as first, second, A, B, (a), (b) or the like, may be used herein to describe components. Each of these terminologies is not used to define an essence, order or sequence of a corresponding component but used merely to distinguish the corresponding component from other component(s). For example, a first component may be referred to as a second component, and similarly the second component may also be referred to as the first component.

Throughout the specification, when a component is described as being “connected to,” or “coupled to” another component, it may be directly “connected to,” or “coupled to” the other component, or there may be one or more other components intervening therebetween. In contrast, when an element is described as being “directly connected to,” or “directly coupled to” another element, there can be no other elements intervening therebetween.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

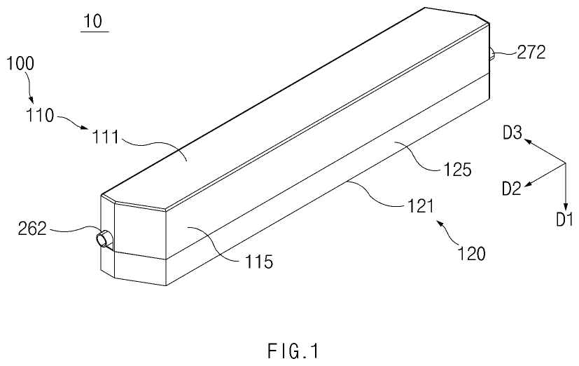

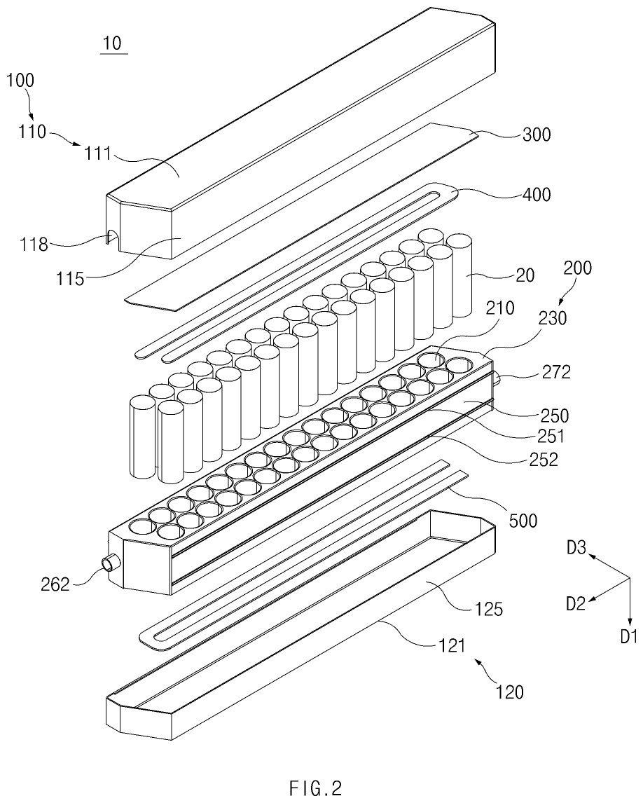

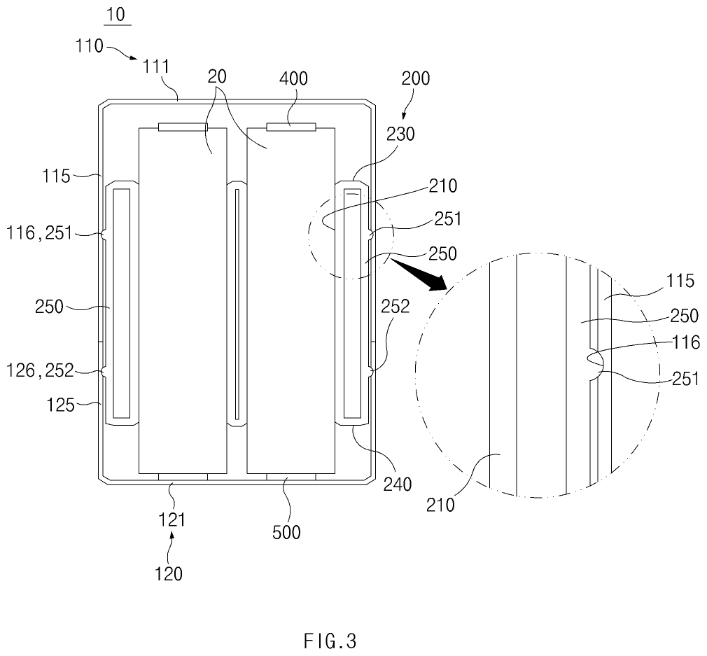

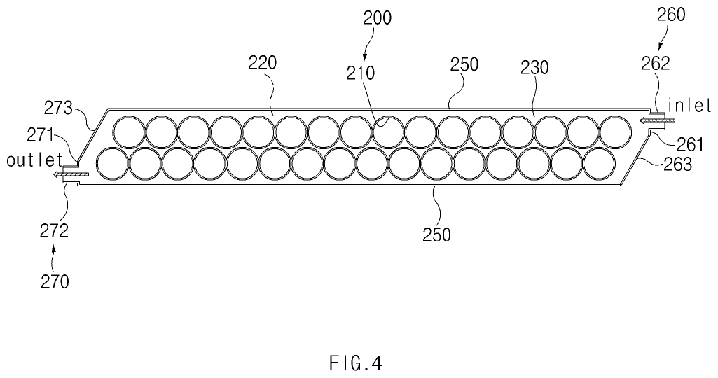

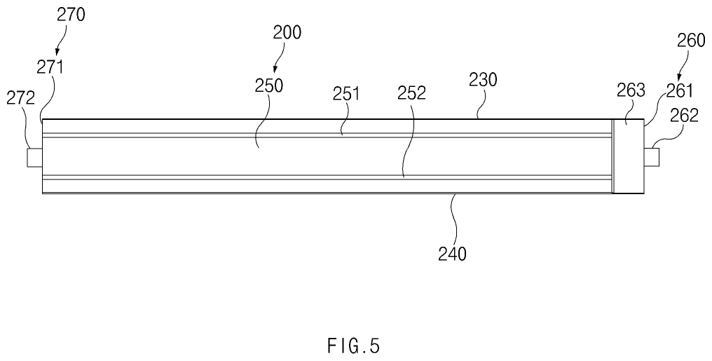

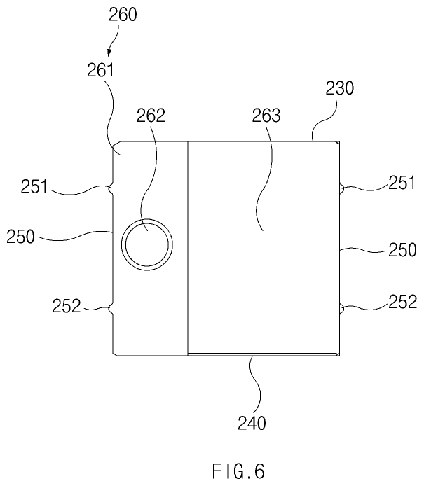

FIG. 1 is a perspective view illustrating a battery pack according to an embodiment of the present disclosure. FIG. 2 is an exploded perspective view illustrating the battery pack according to an embodiment of the present disclosure. FIG. 3 illustrates a sectional view of the battery pack and an enlarged view of a portion of a section of the battery pack according to an embodiment of the present disclosure. FIG. 4 is a top view illustrating a cooling block according to an embodiment of the present disclosure. FIG. 5 is a side view illustrating the cooling block according to an embodiment of the present disclosure. FIG. 6 is a view of the cooling block according to an embodiment of the present disclosure as viewed from an inlet side of the cooling block illustrated in FIG. 2.

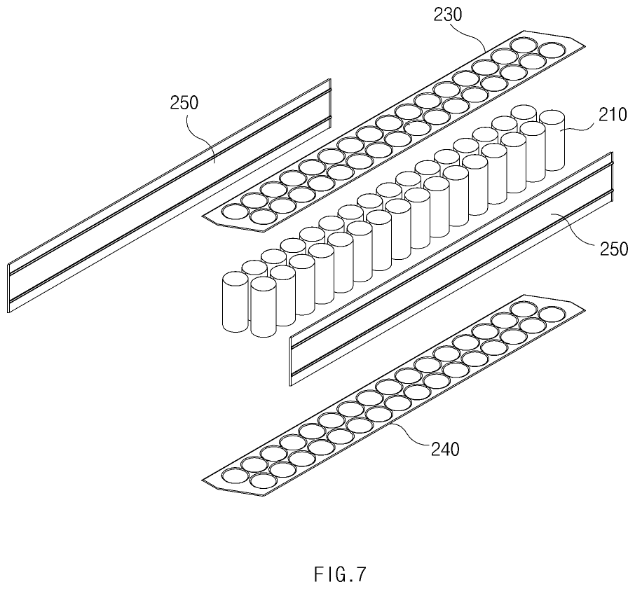

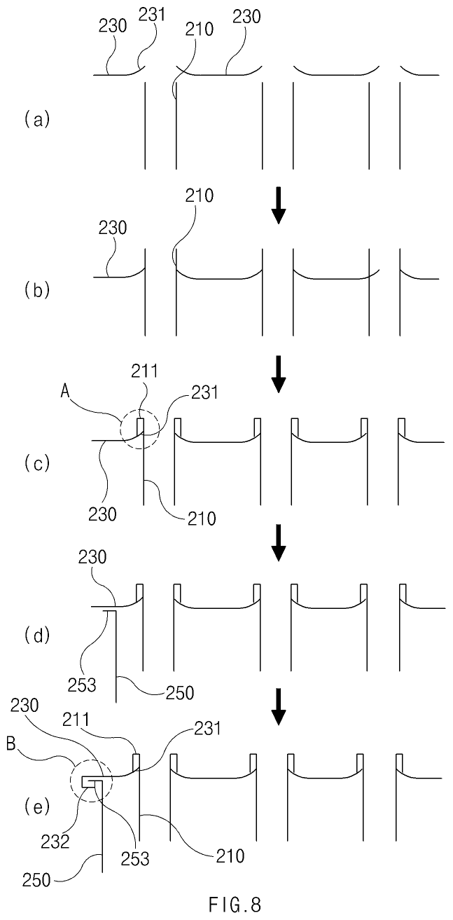

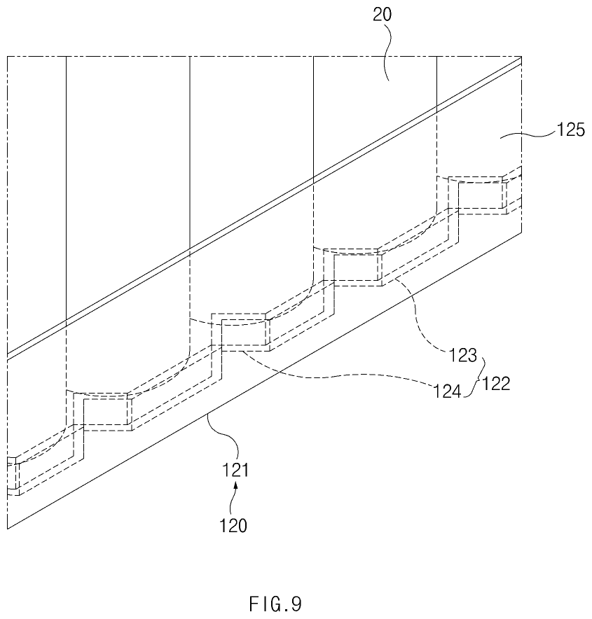

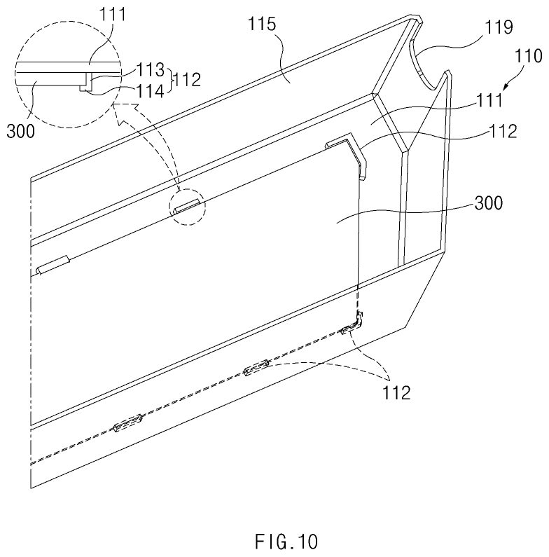

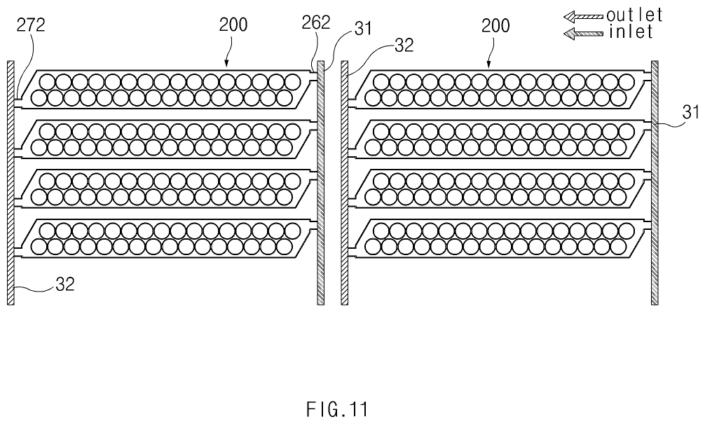

FIG. 7 is a view illustrating a state before the cooling block is assembled according to an embodiment of the present disclosure. FIGS. 8A to 8E are views for describing an assembly process of the cooling block according to an embodiment of the present disclosure. FIG. 9 is a view for describing a structure in which a battery cell is supported by a lower cover in an embodiment of the present disclosure. FIG. 10 is a view for describing a structure in which a sensing assembly is fixed by an upper cover in an embodiment of the present disclosure. FIG. 11 is a view illustrating one example in which a plurality of battery packs are provided according to an embodiment of the present disclosure.

Referring to FIGS. 1 to 11, the battery pack 10 according to an embodiment of the present disclosure includes a housing 100, the battery cell 20, and the cooling block 200.

The housing 100 has a receiving space formed therein. For example, the housing 100 may include the upper cover 110 and the lower cover 120, and the upper cover 110 and the lower cover 120 may be coupled with each other to form the receiving space. Parts constituting the battery pack 10 may be accommodated in the receiving space, and the housing 100 may protect the parts from an external impact.

The battery cell 20 may be accommodated in the receiving space and may be supported by the housing 100, and a plurality of battery cells 20 may be provided. For example, the battery cells 20 may be formed in a cylindrical shape and may be arranged in a grid shape. However, the shape and arrangement of the battery cells 20 are not limited thereto. Hereinafter, a direction toward one end portion based on the extension direction of the cylindrical battery cells 20 is referred to as an upper direction, and a direction toward an opposite end portion is referred to as a lower direction. However, the upper and lower directions may be changed depending on mounting states of the battery pack 10 according to the present disclosure.

An upper end portion and a lower end portion of each of the battery cells 20 may have different polarities. For example, the upper end portion of the battery cell 20 may be formed to be a positive electrode, and the lower end portion of the battery cell 20 may be formed to be a negative electrode. A positive busbar 400 connecting the positive electrodes of the plurality of battery cells 20 may be provided over the battery cells 20, and a negative busbar 500 connecting the negative electrodes of the plurality of battery cells 20 may be provided under the battery cells 20.

The cooling block 200 is accommodated in the receiving space and includes cell insertion parts 210 open at the top and bottom (for example, the cell insertion parts 210 may include openings at the top and the bottom) such that the battery cells 20 are inserted into the cell insertion parts 210 and a cooling chamber 220 in which cooling water flows (see, for example, FIG. 2). Hereinafter, the direction from the upper end portions of the battery cells 20 toward the lower end portions thereof is defined as a first direction D1, the direction that is perpendicular to the first direction D1 and in which the cooling block 200 extends is defined as a second direction D2, and the direction perpendicular to the first direction D1 and the second direction D2 is defined as a third direction D3.

The cooling block 200 may serve to support the plurality of battery cells 20 through the cell insertion parts 210 and may serve to cool the battery cells 20 through the cooling chamber 220 provided in the cooling block 200. The cell insertion parts 210 may be formed in a hollow shape to accommodate the battery cells 20. For example, the cell insertion parts 210 may be formed in a cylindrical shape. However, without being limited thereto, the cell insertion parts 210 may be formed in various shapes, such as an angled shape, depending on the shape of the battery cells 20.

Specifically, the cooling block 200 further includes an upper plate 230, a lower plate 240, and a pair of side plates 250. The upper plate 230 is coupled to upper end portions of the cell insertion parts 210, and the lower plate 240 is coupled to lower end portions of the cell insertion parts 210. The pair of side plates 250 may connect the upper plate 230 and the lower plate 240 and may be spaced apart from each other.

The upper plate 230 and the lower plate 240 may be spaced apart from each other in the first direction D1 and may be disposed parallel to each other. Circular holes may be formed in the upper plate 230 and the lower plate 240 to correspond to the cell insertion parts 210. The side plates 250 may extend in the second direction D2 and may be spaced apart from each other in the third direction D3. That is, the side plates 250 may be vertically provided to connect the upper plate 230 and the lower plate 240 disposed in horizontal positions. The cooling block 200 according to an embodiment of the present disclosure may be formed by assembling the upper plate 230, the lower plate 240, and the side plates 250.

Each of the cell insertion parts 210 may be formed to surround an end of the upper plate 230 and an end of the lower plate 240 in the areas where the cell insertion part 210 meets the upper plate 230 and the lower plate 240. That is, the cell insertion part 210 may be coupled with the upper plate 230 and the lower plate 240 in a hemming structure.

The upper plate 230 and the lower plate 240 may be formed to surround ends of the side plates 250 in the areas where the upper plate 230 and the lower plate 240 meet the side plates 250. More specifically, the upper plate 230 and the lower plate 240 may be coupled with the side plates 250 in a hemming structure.

Hereinafter, a method of coupling the upper and lower plates 230 and 240 with the side plates 250 and the cell insertion parts 210 will be described in detail with reference to FIGS. 7 and 8. As illustrated in FIG. 7, the upper plate 230, the lower plate 240, the side plates 250, and the cell insertion parts 210 may be separately manufactured and thereafter may be coupled together to form the cooling block 200. However, a method of forming the cooling block 200 is not limited to the method to be described below.

The upper plate 230 and the lower plate 240 may each include first curved portions 231 that are formed at portions connected with the cell insertion parts 210 and that have a curved shape. Although FIG. 8 illustrates only the first curved portions 231 of the upper plate 230, the first curved portions 231 may also be formed in the lower plate 240.

The cell insertion parts 210 may each include, at the upper and lower end portions thereof, first hemming portions 211 that are bent toward the upper plate 230 and the lower plate 240 and that surround the first curved portions 231. Overlapping portions of the first hemming portions 211 and the first curved portions 231 may be provided to overlap each other and may be subjected to sealing. For example, the first hemming portions 211 and the first curved portions 231 may be bonded to each other.

Specifically, the areas of the upper plate 230 and the lower plate 240 that meet the cell insertion parts 210 may be entirely or partially curved to form the first curved portions 231. At the portions where the cell insertion parts 210 meet the upper plate 230 and the lower plate 240, the first hemming portions 211 may be formed to surround the first curved portions 231. Because the first hemming portions 211 are bent at the upper and lower end portions of the cell insertion parts 210 and are formed in a structure overlapping the first curved portions 231, the first hemming portions 211 may increase the stiffness of the cooling block 200.

The side plates 250 may each include second curved portions 253 that are formed at portions connected with the upper plate 230 and the lower plate 240 and that have a curved shape.

The upper plate 230 and the lower plate 240 may each include, at end portions facing toward the side plates 250, second hemming portions 232 bent to surround the second curved portions 253. Overlapping portions of the second hemming portions 232 and the second curved portions 253 may be provided to overlap each other and may be subjected to sealing. For example, the second hemming portions 232 and the second curved portions 253 may be bonded to each other.

Specifically, the areas of the side plates 250 that meet the upper plate 230 and the lower plate 240 may be entirely or partially curved to form the second curved portions 253. That is, the second curved portions 253 may be formed at the upper and lower end portions of the side plates 250 based on the second direction D2. The second hemming portions 232 may be provided to surround the second curved portions 253 in the areas where the upper plate 230 and the lower plate 240 meet the side plates 250. Because the second hemming portions 232 are bent at the end portions of the upper plate 230 and the lower plate 240 and are formed in a structure overlapping the second curved portions 253, the second hemming portions 232 may increase the stiffness of the cooling block 200.

Hereinafter, a process of coupling the plates of the cooling block 200 will be described with reference to the example illustrated in FIG. 8.

As illustrated in FIG. 8A, the first curved portions 231 may be formed by bending the end portions of the upper plate 230. As illustrated in FIG. 8B, the cell insertion parts 210 are inserted into the holes formed in the upper plate 230.

As illustrated in FIG. 8C, the first hemming portions 211 surrounding the first curved portions 231 are formed by bending the upper end portions of the cell insertion parts 210 that protrude above the upper plate 230. The spaces between the first hemming portions 211 and the first curved portions 231 are subjected to sealing. Through these processes, the upper plate 230 and the cell insertion parts 210 may be coupled in a hemming structure. Although not illustrated in FIG. 8, the lower plate 240 and the cell insertion parts 210 may also be coupled in a hemming structure by the above-described method.

As illustrated in FIG. 8D, the second curved portions 253 may be formed by bending the upper end portions of the side plates 250. As illustrated in FIG. 8E, the second hemming portions 232 surrounding the second curved portions 253 may be formed by bending the end portions of the upper plate 230. Thereafter, the spaces between the second hemming portions 232 and the second curved portions 253 may be subjected to sealing. Through these processes, the upper plate 230 and the side plates 250 may be coupled in a hemming structure. Although not illustrated in FIG. 8, the lower plate 240 and the side plates 250 may also be coupled in a hemming structure by the above-described method.

Referring to FIGS. 1, 2, and 4 to 6, the cooling block 200 may include an inlet part 260 and an outlet part 270.

The inlet part 260 may be formed at one end of the side plates 250 in the second direction D2 and may have an inlet 262 formed therein through which the cooling water flows into the cooling chamber 220. The outlet part 270 may be formed at an opposite end of the side plates 250 in the second direction D2 and may have an outlet 272 formed therein through which the cooling water flows out of the cooling chamber 220.

As described above, the inlet part 260 and the outlet part 270 may be formed at the opposite ends in the second direction D2 that is the lengthwise direction of the cooling block 200. Accordingly, the cooling water introduced into the cooling chamber 220 through the inlet 262 may evenly cool the plurality of battery cells 20. The cell insertion parts 210 may be installed to surround the side surfaces of the battery cells 20, and the cooling water introduced into the cooling chamber 220 may cool the side surfaces of the battery cells 20.

For example, the inlet part 260 may include an inlet plate 261 and an inclined inlet plate 263.

The inlet plate 261 may be provided at one end of the inlet part 260 in the third direction D3 and may have the inlet 262 formed therein. The inclined inlet plate 263 may extend from the inlet plate 261 toward an opposite end of the inlet part 260 in the third direction D3 and may be inclined toward the outlet part 270 with an approach to the opposite end of the inlet part 260 in the third direction D3.

Due to the inclined shape, the inclined inlet plate 263 may guide the cooling water such that the cooling water introduced through the inlet 262 smoothly flows into the cooling chamber 220.

The outlet part 270 may include an outlet plate 271 and an inclined outlet plate 273.

The outlet plate 271 may be provided at an opposite end of the outlet part 270 in the third direction D3 and may have the outlet 272 formed therein. The inclined outlet plate 273 may extend from the outlet plate 271 toward one end of the outlet part 270 in the third direction D3 and may be inclined toward the inlet part 260 with an approach to the one end of the outlet part 270 in the third direction D3.

Due to the inclined shape, the inclined outlet plate 273 may guide, toward the outlet 272, the cooling water flowing toward the opposite end of the cooling chamber 220 in the second direction D1 to smoothly discharge the cooling water to the outside.

The inlet 262 may be connected with a cooling-water supply, and cooling water introduced through the inlet 262 may cool the battery cells 20 while flowing in the cooling chamber 220 and may be discharged through the outlet 272. Because the cooling chamber 220 of the cooling block 200 is sealed, contact portions of the cooling block 200 and the battery cells 20 may be insulated, and thus the entire battery pack 10 may secure electrical stability.

As described above, the inlet 262 is provided at the one end of the inlet part 260 in the third direction D3, and the outlet 272 is provided at the opposite end of the outlet part 270 in the third direction D3. Accordingly, the path of the cooling water flowing in the cooling chamber 220 is lengthened. For example, the illustrated third direction D3 may be an up/down direction depending on an installation environment of the battery pack 10. In this case, the inlet 262 may be formed in a higher position than the outlet 272, and cooling water introduced through the inlet 262 formed in the higher position may flow in the cooling chamber 220 and may be discharged through the outlet 272 formed in a lower position.

The housing 100 may include the upper cover 110 covering the upper end portions of the battery cells 20 and the lower cover 120 forming the receiving space together with the upper cover 110 and covering the lower end portions of the battery cells 20.

The upper cover 110 and the lower cover 120 may be coupled to the cooling block 200 by a snap-fit connection. Accordingly, the upper cover 110, the lower cover 120, and the cooling block 200 may be simply and rapidly assembled, and the number of parts and manufacturing cost may be reduced because a separate part for assembly is not required.

Specifically, referring to FIGS. 2 and 3, the cooling block 200 may include first assembly protrusions 251 and second assembly protrusions 252 that protrude from the side plates 250 and extend in the second direction D2 and that are spaced apart from each other in the first direction D1.

The upper cover 110 may include, on the inside surfaces thereof, first insertion grooves 116 into which the first assembly protrusions 251 are inserted, and the lower cover 120 may include, on the inside surfaces thereof, second insertion grooves 126 into which the second assembly protrusions 252 are inserted.

As the first assembly protrusions 251 are inserted into the first insertion grooves 116, the upper cover 110 may be assembled to the cooling block 200. As the second assembly protrusions 252 are inserted into the second insertion grooves 126, the lower cover 120 may be assembled to the cooling block 200. Unlike the above description, hook structures may be formed on the lower end portion of the upper cover 110 and the upper end portion of the lower cover 120. In this case, the upper cover 110 and the side plates 250 may be hooked together, and the lower cover 120 and the side plates 250 may be hooked together.

After the upper cover 110 and the lower cover 120 are assembled to the cooling block 200, the upper cover 110, the lower cover 120, and the side plates 250 may be bonded by thermal fusion or welding. For example, the thermal fusion or welding may be performed on the areas where the upper cover 110, the lower cover 120, and the side plates 250 meet one another. Accordingly, the upper cover 110, the lower cover 120, and the cooling block 200 may be fixed in the assembled state, and thus the fixing force may be strengthened. Due to this, the air-tightness of the housing 100 may be strengthened.

Thus, the housing 100 may protect the battery cells 20 from an external impact, may secure an insulating structure for insulating the battery cells 20, and may minimize infiltration of foreign matter into the housing 100.

As described above, the cooling block 200 may include the inlet 262 formed at the one end of the cooling block 200 in the second direction D2 and the outlet 272 formed at the opposite end of the cooling block 200 in the second direction D2. The upper cover 110 may include an inlet recess 118 that is formed in one end portion of the upper cover 110 in the second direction D2 and through which the inlet 262 passes and an outlet recess 119 that is formed in an opposite end portion of the upper cover 110 in the second direction D2 and through which the outlet 272 passes.

Referring to FIG. 10, the battery pack 10 according to an embodiment of the present disclosure may further include the sensing assembly 300 configured to monitor the voltages of the battery cells 20. The sensing assembly 300 for sensing voltage states of the battery cells 20 may include a circuit board and may be provided between the positive busbar 400 and the upper cover 110.

The upper cover 110 may include an upper horizontal plate 111 provided to be horizontal and upper vertical plates 115 formed perpendicular to the upper horizontal plate 111 and assembled to the cooling block 200. The upper horizontal plate 111 may include fixing protrusions 112 that are formed on the inside surface facing toward the receiving space and to which the sensing assembly 300 is fixed.

Specifically, the sensing assembly 300 or the circuit board included therein may make contact with the inside surface of the upper horizontal plate 111 of the upper cover 110, and the fixing protrusions 112 may be spaced apart from each other along the periphery of the circuit board. For example, as illustrated in FIG. 10, each of the fixing protrusions 112 may include an extension 113 protruding from the upper horizontal plate 111 and a stopper 114 extending from the extension 113 at a right angle, and the edges of the sensing assembly 300 may be stopped by the stoppers 114 and may be fixed to the fixing protrusions 112.

Referring to FIG. 9, the lower cover 120 may include a lower horizontal plate 121 provided to be horizontal and lower vertical plates 125 formed perpendicular to the lower horizontal plate 121 and assembled to the cooling block 200. The second insertion grooves 126 may be formed on the lower vertical plates 125, and the second assembly protrusions 252 formed on the side plates 250 may be inserted into the second insertion grooves 126.

The lower horizontal plate 121 may include a support guide 122. The support guide 122 may protrude from the inside surface of the lower horizontal plate 121 that faces toward the receiving space. The support guide 122 may guide arrangement of the battery cells 20 and may support the lower end portions of the battery cells 20. The lower end portions of the battery cells 20 may be stably supported by the support guide 122.

That is, the lateral portions of the battery cells 20 may be supported by the cell insertion parts 210 of the cooling block 200, and the lower end portions of the battery cells 20 may be supported by the support guide 122. Accordingly, the battery cells 20 may be stably installed in the housing 100. The battery cells 20 may be stably protected from an external impact by the support structures of the cooling block 200 and the lower cover 120.

Specifically, the support guide 122 may be formed along the edges of the end portions of the plurality of battery cells 20 that face the first direction D1.

The support guide 122 may include support portions 123 brought into close contact with the side surfaces of the battery cells 20 to support the battery cells 20 and protrusions 124 that extend from the support portions 123 so as to be bent and that are provided to correspond to the positions between the plurality of battery cells 20. The support guide 122 may be vertically provided on the inside surface of the lower horizontal plate 121, and the protrusions 124 may be bent in the direction from the support portions 123 toward the battery cells 20.

The support guide 122 may support the lower end portions of the battery cells 20 by the support portions 123 and may align the plurality of battery cells 20 by the protrusions 124 such that the positions of the battery cells 20 are maintained.

Meanwhile, depending on the type or use of a vehicle, the size or capacity of the battery pack 10 needs to be increased as needed. In the related art, battery packs for respective vehicle models are separately manufactured by increasing the size of a part including cylindrical battery cells, and therefore manufacturability is deteriorated.

Referring to FIG. 11, according to an embodiment of the present disclosure, a plurality of battery packs 10 may be stacked in the longitudinal and lateral directions, a main cooling-water inlet line 31 may connect a plurality of inlets 262, and a main cooling-water outlet line 32 may connect a plurality of outlets 272. Cooling water supplied through the main cooling-water inlet line 31 may flow into cooling chambers 220 of cooling blocks 200 through the inlets 262. The cooling water flowing in the cooling chambers 220 may flow from the outlets 272 to the main cooling-water outlet line 32 and thereafter may be discharged to the outside.

The size and capacity of the entire battery pack may be easily and rapidly changed by stacking the battery packs 10 in multiple layers and adding only the main cooling-water inlet line 31 and the main cooling-water outlet line 32 as described above. Accordingly, it is possible to respond to vehicles of various types and sizes, and the manufacturability of the battery pack 10 may be improved.

As described above, the battery pack according to the embodiments of the present disclosure is configured such that the cooling block supports the battery cells while cooling the battery cells, and thus a separate cartridge for supporting the battery cells is not required. Accordingly, the number of parts may be minimized, and the use of the inner space may be maximized.

Each step included in the method described above may be implemented as a software module, a hardware module, or a combination thereof, which is executed by a computing device.

Also, an element for performing each step may be respectively implemented as first to two operational logics of a processor.

The software module may be provided in RAM, flash memory, ROM, erasable programmable read only memory (EPROM), electrical erasable programmable read only memory (EEPROM), a register, a hard disk, an attachable/detachable disk, or a storage medium (i.e., a memory and/or a storage) such as CD-ROM.

An exemplary storage medium may be coupled to the processor, and the processor may read out information from the storage medium and may write information in the storage medium. In other embodiments, the storage medium may be provided as one body with the processor.

The processor and the storage medium may be provided in application specific integrated circuit (ASIC). The ASIC may be provided in a user terminal. In other embodiments, the processor and the storage medium may be provided as individual components in a user terminal.

Exemplary methods according to embodiments may be expressed as a series of operation for clarity of description, but such a step does not limit a sequence in which operations are performed. Depending on the case, steps may be performed simultaneously or in different sequences.

In order to implement a method according to embodiments, a disclosed step may additionally include another step, include steps other than some steps, or include another additional step other than some steps.

The present disclosure has been made in an effort to solve the problems in the related art, and an object of the present disclosure is to provide a battery pack with improved durability against an external impact and insulation while improving cooling performance, thereby securing safety. In addition, according to the embodiments of the present disclosure, the number of parts may be minimized, and thus a rise in cost may be minimized.

An aspect of the present disclosure provides a battery pack for maximizing the use of inner space while minimizing the number of parts by excluding a separate cartridge for supporting battery cells.

Another aspect of the present disclosure provides a battery pack for securing safety by improving durability against an external impact and insulation while improving cooling performance.

Accordingly, a technology for improving stiffness, insulation performance, and cell cooling performance at the same time as increasing the use of space in a module by minimizing the number of additional parts is required.

In accordance with example embodiments, the cartridge supporting the battery cells and the cooling block cooling the battery cells are manufactured together, and therefore in these instances the space in the battery pack is used efficiently. Additionally, the cartridge and the cooling block may not require a separate assembly structure to bring the battery cells and the cooling block into close contact with each other, thus improving manufacturability. In addition, in the event of damage by an external impact the improved insulation performance reduces the risk of electrical hazard.

Various embodiments of the present disclosure do not list all available combinations but are for describing a representative aspect of the present disclosure, and descriptions of various embodiments may be applied independently or may be applied through a combination of two or more.

Moreover, various embodiments of the present disclosure may be implemented with hardware, firmware, software, or a combination thereof. In a case where various embodiments of the present disclosure are implemented with hardware, various embodiments of the present disclosure may be implemented with one or more application specific integrated circuits (ASICs), digital signal processors (DSPs), digital signal processing devices (DSPDs), programmable logic devices (PLDs), field programmable gate arrays (FPGAs), general processors, controllers, microcontrollers, or microprocessors.

The scope of the present disclosure may include software or machine-executable instructions (for example, an operation system (OS), applications, firmware, programs, etc.), which enable operations of a method according to various embodiments to be executed in a device or a computer, and a non-transitory computer-readable medium capable of being executed in a device or a computer each storing the software or the instructions.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A battery pack comprising:
a housing having a receiving space formed therein;
a plurality of battery cells accommodated in the receiving space and supported by the housing; and
a cooling block accommodated in the receiving space, wherein the cooling block includes cell insertion parts, each cell insertion part including a top opening and a bottom opening, such that the battery cells are inserted into the cell insertion parts and a cooling chamber in which cooling water flows,
wherein the cooling block further includes:
an upper plate coupled to upper end portions of the cell insertion parts;
a lower plate coupled to lower end portions of the cell insertion parts; and
a pair of side plates configured to connect the upper plate and the lower plate, and
wherein the cell insertion parts are formed to surround ends of the upper plate and ends of the lower plate in areas in which the cell insertion parts meet the upper plate and the lower plate.

2. The battery pack of claim 1, wherein the upper plate and the lower plate are formed to surround ends of the side plates in areas in which the upper plate and the lower plate meet the side plates.

3. The battery pack of claim 1, wherein a direction from upper end portions of the battery cells toward lower end portions thereof is referred to as a first direction,
wherein the side plates extend in a second direction, wherein the second direction is a direction in which the cooling block extends that is perpendicular to the first direction, and are spaced apart from each other in a third direction, wherein the third direction is a direction that is perpendicular to the first direction and to the second direction.

4. The battery pack of claim 1, wherein the upper plate and the lower plate include first curved portions formed at portions connected with the cell insertion parts and having a curved shape, and
wherein the cell insertion parts include, at the upper and lower end portions thereof, first hemming portions bent toward the upper plate and the lower plate and formed to surround the first curved portions.

5. The battery pack of claim 4, wherein the side plates include second curved portions formed at portions connected with the upper plate and the lower plate and having a curved shape, and
wherein the upper plate and the lower plate include, at end portions facing toward the side plates, second hemming portions bent to surround the second curved portions.

6. The battery pack of claim 3, wherein the cooling block includes:
an inlet part formed at one end of the side plates in the second direction, the inlet part having an inlet formed therein through which the cooling water flows into the cooling chamber; and
an outlet part formed at an opposite end of the side plates in the second direction, the outlet part having an outlet formed therein through which the cooling water flows out of the cooling chamber.

7. The battery pack of claim 6, wherein the inlet part includes:
an inlet plate provided at one end of the inlet part in the third direction, the inlet plate having the inlet formed therein; and
an inclined inlet plate configured to extend from the inlet plate and inclined toward the outlet part with an approach to an opposite end of the inlet part in the third direction, and
wherein the outlet part includes:
an outlet plate provided at an opposite end of the outlet part in the third direction, the outlet plate having the outlet formed therein; and
an inclined outlet plate configured to extend from the outlet plate and inclined toward the inlet part with an approach to one end of the outlet part in the third direction.

8. The battery pack of claim 3, wherein the housing includes:
an upper cover configured to cover the upper end portions of the battery cells; and
a lower cover configured to form the receiving space together with the upper cover and cover the lower end portions of the battery cells, and
wherein the upper cover and the lower cover are coupled to the cooling block by a snap-fit connection.

9. The battery pack of claim 8, wherein the cooling block includes upper assembly protrusions and lower assembly protrusions configured to protrude from the side plates and extend in the second direction and spaced apart from each other in the first direction,
wherein the upper cover includes, on inside surfaces thereof, upper insertion grooves into which the upper assembly protrusions are inserted, and
wherein the lower cover includes, on inside surfaces thereof, lower insertion grooves into which the lower assembly protrusions are inserted.

10. The battery pack of claim 8, wherein the upper cover, the lower cover, and the side plates are bonded by thermal fusion or welding.

11. The battery pack of claim 8, wherein the cooling block includes
an inlet formed at one end of the cooling block in the second direction and an outlet formed at an opposite end of the cooling block in the second direction, and
wherein the upper cover includes
an inlet recess
that is formed in one end portion of the upper cover in the second direction and through which the inlet passes, and
an outlet recess
that is formed in an opposite end portion of the upper cover in the second direction and through which the outlet passes.

12. The battery pack of claim 8, further comprising:
a sensing assembly configured to monitor voltages of the battery cells,
wherein the upper cover includes an upper horizontal plate provided to be horizontal and an upper vertical plate formed perpendicular to the upper horizontal plate and assembled to the cooling block, and
wherein the upper horizontal plate includes at least one fixing protrusion that is formed on an inside surface facing toward the receiving space and to which the sensing assembly is fixed.

13. The battery pack of claim 12, wherein the at least one fixing protrusion includes a plurality of fixing protrusions spaced apart from each other along a periphery of a circuit board included in the sensing assembly, and the plurality of fixing protrusions are coupled to edges of the circuit board by a snap-fit connection.

14. The battery pack of claim 8, wherein the lower cover includes a lower horizontal plate provided to be horizontal and a lower vertical plate formed perpendicular to the lower horizontal plate and assembled to the cooling block, and
wherein the lower horizontal plate includes a support guide configured to protrude from an inside surface of the lower horizontal plate facing toward the receiving space, to guide arrangement of the battery cells, and to support the lower end portions of the battery cells.

15. The battery pack of claim 14, wherein the support guide is formed along edges of end portions of the plurality of battery cells facing the first direction, and
wherein the support guide includes support portions brought into close contact with side surfaces of the battery cells to support the battery cells and protrusions configured to extend from the support portions so as to be bent, the protrusions being provided to correspond to positions between the plurality of battery cells.
